(19) United States
(12) Patent Application Publication
(10) Pub. No.: US 2026/0163258 A1
(43) Pub. Date: Jun. 11, 2026

(54) CONTACT BRIDGE FOR CONNECTING TWO BUSBARS AND CONNECTOR WITH A CONTACT BRIDGE

(71) Applicant: TE Connectivity Solutions GmbH, Schaffhausen (CH)

(72) Inventor: Markus ECKEL, Schaffhausen (CH)

(21) Appl. No.: 19/407,117

(22) Filed: Dec. 3, 2025

(30) Foreign Application Priority Data
Dec. 5, 2024 (DE) 102024136289.8

(51) Int. Cl. H01R 4/48

(52) U.S. Cl. CPC H01R 4/4809

(57) ABSTRACT

A contact bridge for connecting a first busbar to a second busbar includes a first clamp mouth for at least partially receiving the first busbar, a second clamp mouth facing away from the first clamp mouth for at least partially receiving the second busbar, and a spring assembly against which the first clamp mouth and the second clamp mouth are each configured to be openable, wherein the first clamp mouth is connected to the second clamp mouth in an electrically conductive and motion-transmitting manner. This ensures that compensating movements required to overcome positional tolerances between the busbars are distributed evenly between the first and second clamping jaws. Furthermore, a housing for the contact bridge and a connector with such a contact bridge is provided.

### CROSS REFERENCE TO RELATED APPLICATIONS

This application claims the benefit of DE Application No. 102024136289.8, filed 5 Dec. 2024, the subject matter of which is herein incorporated by reference in its entirety.

### BACKGROUND OF THE INVENTION

The subject matter herein relates generally to a contact bridge for connecting two busbars. Furthermore, the subject matter herein relates to a housing for such a contact bridge. In addition, the subject matter herein relates to a connector with a contact bridge and a housing.

Busbars are used in a wide variety of technical fields to transmit electrical currents and/or signals between electrical modules. Often, each of these electrical modules has its own busbar, so that, for example, the respective ends of the busbars must be connected to each other.

This connection is made more difficult by the fact that the relative position between the busbar ends to be connected is subject to certain tolerance-related fluctuations. For example, the busbar ends may be inclined and/or offset in height relative to each other. In addition, the relative position of the busbar ends may change due to thermal expansion during operation of the electrical modules.

To compensate for these positional tolerances in busbars, flexible conductor sections, for example made of braided copper wire, are often provided, which make it possible to adjust the position of the busbar ends to different relative positions. However, these flexible conductor sections are costly to manufacture and must be incorporated into the geometry of the busbars in advance. In addition, the busbars then have to be bent into shape, sometimes with considerable force, whereby one of the busbars is often bent more than the other. This can unnecessarily increase the amount of force required, especially if the busbars have different degrees of rigidity or if the bending does not take place in the linear elastic range.

Therefore, a need exists to connect electrical modules, in particular their busbars, with as little effort as possible, despite positional tolerances.

### BRIEF DESCRIPTION OF THE INVENTION

In one embodiment, means are provided for connecting electrical busbars with which position tolerances can be compensated easily, evenly, and irrespective of geometry.

In an embodiment, a contact bridge is provided for connecting a first busbar to a second busbar that includes a first clamp mouth for at least partially receiving the first busbar, a second clamp mouth facing away from the first clamp mouth for at least partially receiving the second busbar, and a spring assembly against which the first clamp mouth and the second clamp mouth are each configured to be openable, wherein the first clamp mouth is connected to the second clamp mouth in an electrically conductive and motion-transmitting manner.

According to an embodiment, the contact bridge is configured as a spring-loaded double clamp or double-sided clamp, which can be attached to the busbars in order to bridge them. Since the first and second clamp mouths are electrically conductively connected to each other, an electric current and/or an electric signal can be transmitted via the contact bridge when, for example, one end of the first busbar is received in the first clamp mouth and one end of the second busbar is received in the second clamp mouth.

The first and second clamp mouths are configured to be openable or expandable against the spring assembly, so that an elastic restoring force of the spring assembly must be overcome when opening or expanding the respective first or second clamp mouth. This elastic restoring force of the spring assembly in turn allows the contact bridge to apply the necessary contact force against the inserted busbars.

Furthermore, the first and second clamp mouths are connected to each other in such a way that a movement (e.g., opening or closing) of the first clamp mouth produces a movement (e.g., opening or closing) in the second clamp mouth and vice versa. This ensures that any compensatory movements necessary to overcome positional tolerances are distributed evenly between the first and second clamp mouths. The busbars themselves do not need to have flexible conductor sections, as the compensatory movements can take place in the clamp mouths and the spring assembly.

Consequently, the contact bridge provides a simple means of connecting the busbars with uniform tolerance compensation, regardless of their busbar geometry.

The above solution can be further improved with the additional embodiments described below. The individual embodiments are each advantageous on their own and can be combined with each other arbitrarily.

According to one possible embodiment, the spring assembly may extend at least partially between the first clamp mouth and the second clamp mouth, resulting in a space-saving arrangement. Optionally, the spring assembly may form a stop for the first and second busbars. This improves the handling of the contact bridge, as a fixed end point is defined for each insertion movement when receiving the busbars.

In other words, the spring assembly may separate the first clamp mouth from the second clamp mouth. Alternatively, the first and second clamp mouths may form a continuous receiving channel, with the spring assembly surrounding the receiving channel. In this embodiment, the busbars can come into direct contact with each other within the continuous receiving channel, thus improving the flow of current and/or signals.

In order to achieve the most even distribution of force possible, the spring assembly may be positioned centrally between the first clamp mouth and the second clamp mouth. If the ends of the first and second busbars have the same geometry, the first clamp mouth may be configured to be the same size as the second clamp mouth. In particular, the first and second clamp mouths may be configured symmetrically with respect to the spring assembly. If there are differences in the geometries of the busbar ends, this may be reflected in the size and shape of the clamp mouths.

According to a further possible embodiment, the contact bridge may comprise a first pair of clamping jaws forming the first clamp mouth and a second pair of clamping jaws forming the second clamp mouth. Each pair of clamping jaws may define a clamping gap that is accessible from one, two, or three mutually perpendicular directions for the respective busbar end to be received. In other words, there is a first clamping gap for the first busbar between the first pair of clamping jaws and a second clamping gap for the second busbar between the second pair of clamping jaws.

The clamping jaws of the pairs of clamping jaws may be held movable relative to each other under elastic deformation of the spring assembly. In particular, the spring assembly may form a bearing point or pivot point for the first pair of clamping jaws and the second pair of clamping jaws. In other words, the clamping jaws of the pairs of clamping jaws may be mounted in a rocking, tilting, or pivoting manner by a section of the spring assembly. Here, the imaginary bearing point or pivot point may be located inside the spring assembly or outside the spring assembly.

According to a further possible embodiment, the contact bridge may comprise a first bracket element extending along a longitudinal direction and a second bracket element spaced transversely, in particular perpendicularly to the longitudinal direction, from the first bracket element. Optionally, the second bracket element may be configured identically to the first bracket element and arranged mirror-invertedly with respect to the spring assembly. In particular, when the contact bridge is in a force-free state, the second bracket element may then extend parallel to the first bracket element in the longitudinal direction. When the contact bridge is installed, the longitudinal direction may run along a connecting line between the first busbar and the second busbar. The longitudinal direction thus corresponds to a busbar bridging direction.

The above-mentioned motion-transmitting connection between the first and second clamp mouths can be easily achieved if the first bracket element forms a first clamping jaw of the first pair of clamping jaws and a first clamping jaw of the second pair of clamping jaws, while the second bracket element forms a second clamping jaw of the first pair of clamping jaws and a second clamping jaw of the second pair of clamping jaws. The pairs of clamping jaws are thus coupled to each other in their movement via the bracket elements.

In this embodiment, the first and second bracket elements each extend from the first clamping gap to the second clamping gap. Thus, the above-mentioned electrically conductive connection between the first and second clamp mouths can also be realized via the bracket elements.

In addition, the first and second bracket elements are opposite each other with respect to the first and second clamping gaps. In other words, a distance measured perpendicular to the longitudinal direction between the first and second bracket elements corresponds to a clear width of the first and second clamp mouths.

According to another possible embodiment, the spring assembly may comprise a retaining spring that connects the first bracket element to the second bracket element in a form-fitting and/or material-joining manner. In other words, there may be a form-fitting and/or material-joining connection between the retaining spring and the first bracket element, as well as a further form-fitting and/or material-joining connection between the retaining spring and the second bracket element. Thus, the first bracket element, the second bracket element, and the retaining spring may each be present as separate components in an initial state. This allows for flexible material selection, so that the bracket elements can be made of an electrically conductive material and the retaining spring can be made of another material with a higher elasticity limit.

Alternatively, the first clamp mouth, the second clamp mouth, and the spring assembly may be configured as a single piece, in particular as a monolithic piece. This reduces the cost of manufacturing, transport, and storage, as the contact bridge can be provided as an integral component (e.g., a stamped and bent part). In particular, the integral component may comprise a first leg section and a second leg section for bridging the first and second busbars, respectively, as well as a spring section for clamping (i.e., compressing or contracting) the first and second leg sections together.

The spring section extends from the first leg section to the second leg section and is functionally comparable to the retaining spring. The first and second leg sections correspond in their function and position to the first and second bracket elements. As such, the first and second leg sections each extend from the first clamping gap to the second clamping gap. In addition, the first and second leg sections are opposite each other with respect to the first and second clamping gaps.

A space-saving embodiment is achieved when the first bracket element, the second bracket element, the retaining spring, and/or the integral component are each configured as flat bodies. A flat body is a flat, planar, plate-shaped or tab-shaped component with one spatial dimension being many times smaller than its other dimensions. As such, the first bracket element, the second bracket element, the retaining spring, and/or the integral component may each comprise two flat sides that point away from each other and whose distance corresponds to the small spatial dimension mentioned above.

In order to give the first bracket element, the second bracket element, and/or the retaining spring sufficient rigidity despite their flat body design, it is advisable to align their flat sides parallel to the above-mentioned clear width of the first and second clamp mouths. In other words, the first bracket element, the second bracket element, and/or the retaining spring may be arranged upright with respect to the busbars. This increases the area moment of inertia of the respective flat body.

According to a further possible embodiment, the first bracket element may comprise a first contact area that tapers the first clamp mouth and a second contact area that tapers the second clamp mouth. Similarly, the second bracket element may comprise a first contact area that tapers the first clamp mouth and a second contact area that tapers the second clamp mouth. In particular, the contact areas may create constrictions in the respective clamp mouth by protruding into the interior of the respective clamping gap. The first clamp mouth may thus comprise a first constriction and the second clamp mouth may comprise a second constriction. The constrictions result in greater surface pressure, which increases the contact force against the received busbars.

In particular, the first and/or second contact area of the first bracket element and/or the first and/or second contact area of the second bracket element may each comprise a tip. The tip may be formed by a rounded projection or an angular notch of the corresponding bracket element. Advantageously, the contact bridge can roll on the busbars with the respective tip. This means that between each individual pair of tip and busbar there is no predefined, (meta-)stable angular position, but rather a continuous range of relative angular positions that can be assumed. This facilitates the aforementioned compensating movements to overcome positional tolerances.

Optionally, the respective tip may comprise an insertion bevel for the busbar to be received. From the perspective of the received busbar, the first clamp mouth may widen behind the first constriction and the second clamp mouth may widen behind the second constriction. These widenings give the respective busbar increased freedom of movement, which facilitates the aforementioned compensating movements.

In addition or alternatively, the first and/or second contact area of the first bracket element and/or the first and/or second contact area of the second bracket element may each comprise a double tip. The double tip may be two rounded or angular tips that are aligned in the longitudinal direction. Perpendicular to the longitudinal direction, the two tips are of equal length, so that the double tip defines a central alignment when the contact bridge is clamped to a busbar on one side.

In order to achieve additional flexibility in the contact areas, the respective tip and/or the respective double tip may be angled or bent relative to the rest of the contact bridge. This means that an angle other than 180° is enclosed between the individual tips and the rest of the contact bridge.

According to a further possible embodiment, the contact bridge may comprise a plurality of first bracket elements that are arranged congruently or coincidently to each other, and a plurality of second bracket elements that are arranged congruently or coincidently to each other. The first bracket elements may be displaceable relative to each other, as may the second bracket elements. In other words, in this embodiment, several first bracket elements and second bracket elements are arranged side by side or stacked on top of each other, so that the contact bridge has a larger overall conductor cross-sectional area.

Optionally, the contact bridge may comprise an equal or symmetrical number of first and second bracket elements. The spring assembly may in turn comprise a corresponding number of retaining springs that are arranged congruently and movably relative to each other, with each retaining spring connecting a first bracket element to a second bracket element in pairs.

In other words, one first bracket element, one second bracket element, and one retaining spring may together form a bridge unit, with the contact bridge consisting of a stack of such bridge units. Due to the congruent arrangement of the first bracket elements, second bracket elements, and retaining springs with each other, the entirety of all first clamping gaps of the bridge units results in the (common) first clamp mouth, and the entirety of all second clamping gaps of the bridge units results in the (common) second clamp mouth.

Thanks to this design, tolerance compensation can also take place if the first and second busbars are rolled relative to each other due to tolerances (i.e., rotated around the busbar bridging direction). This is because the bridge units of the contact bridge can be fanned out due to their movability. As long as there is a certain overlap between all adjacent clamping gaps, the individual clamping gaps can be shifted relative to each other by fanning them out, resulting in a “distorted” overall gap in the respective clamp mouth. In summary, the (shared) first clamp mouth can be rotated relative to the (shared) second clamp mouth, allowing the busbars rolled relative to each other to be connected by the contact bridge.

Since each bridge unit has its own retaining spring, which is mechanically independent of the other retaining springs of the other bridge units, the contact forces within each bridge unit are reliably exerted by its own retaining spring even after a strong tolerance compensation. According to an alternative embodiment that is easy to manufacture, the spring assembly may also comprise only one retaining spring that bundles and collectively connects all first and second bracket elements.

The object described at the outset can also be achieved by means of a housing for a contact bridge according to one of the embodiments described above. In this case, the housing may be configured to accommodate the contact bridge. The housing is thus able to protect the contact bridge from external influences and can also simplify the handling of the contact bridge.

According to one possible embodiment, the housing may comprise a first access opening for inserting the first busbars and a second access opening for inserting the second busbars. When the contact bridge is accommodated in the housing, the first access opening may open into the first clamp mouth and the second access opening may open into the second clamp mouth. The size and shape of the access openings prevent the ingress of foreign objects, so that the housing may serve as finger protection.

Optionally, the housing may comprise a first housing part forming the first access opening and a second housing part forming the second access opening, wherein the first and second housing parts are held together in an angularly movable manner. The angular mobility describes the fact that an angle between the housing parts is variable. For example, the housing parts may form a joint inside which the contact bridge is located.

The angular mobility or flexibility allows the housing parts to be aligned to the orientations of the busbars to be received. In particular, the same angle may be set between the housing parts as exists between the busbars. This allows the access openings in particular to be aligned flush and perpendicular with the respective busbar. Consequently, the access openings may be dimensioned to fit the busbar geometry precisely and still accommodate the busbars in different orientations and heights. Without this angular mobility or flexibility, the access openings would have to be oversized in order to accommodate busbars in different orientations and heights. However, this would impair the finger protection function.

If the contact bridge is a stack of several bridge units as described above, the housing may bundle this stack. Optionally, the housing may comprise at least one spacer grid with a plurality of parallel spacer ribs. The spacer ribs may be configured as internal ribs that protrude into the interior of the housing and between the individual bridge units. This allows the spacer grid to serve to position the individual bridge units, in particular the plurality of first and second bracket elements, at predefined intervals, for example at regular intervals. In addition, the spacer grid may be configured to align the bridge units within the housing in the busbar bridging direction.

Alternatively, the contact bridge may be provided as a stack of several integral components with the leg sections and the spring section already described above. In this case, the housing may be used to bundle, align, and grid the stack as well.

Increased finger protection can be achieved if the housing comprises at least one finger protection grid for attachment to the first and/or second busbar. The finger protection grid may be provided in addition to the first and second housing parts or may constitute one of these. Furthermore, the finger protection grid may be configured as a comb, grid, grate, grill, or gate-shaped structure that can be placed on the end of the first or second busbar. In particular, the finger protection grid may comprise a plurality of parallel finger protection ribs which, when in place, enclose the end of the first or second busbar.

The finger protection ribs are dimensioned such that neither a VDE test finger nor a human finger can touch the enclosed busbar, while contact with the contact bridge is possible without obstruction. To achieve this, the pitch of the finger protection ribs may be smaller than the tip of the VDE test finger and at the same time correspond to the pitch of the spacer ribs. The pitch describes the respective distance between adjacent ribs. Furthermore, the finger protection ribs and spacer ribs may have the same width or material thickness. This ensures that the bridge units of the contact bridge positioned by the spacer grid fit exactly between the finger protection ribs of the finger protection grid and thus reach the busbar.

The first and/or second access opening of the housing may in turn be dimensioned so that the VDE test finger cannot be inserted up to the first or second clamp mouth, while a busbar with the finger protection grid can fit in unhindered. For this purpose, additional finger protection ribs may be provided in the first and/or access opening, which cover the first or second clamp mouth in the busbar bridging direction. These additional finger protection ribs are complementary to the finger protection ribs of the finger protection grid in terms of their number, shape, and position.

In order to compensate for any positional tolerances of the finger protection grid, it is advisable to mount the finger protection grid so that it can be moved on the first or second busbar.

The object defined at the outset can also be achieved by a connector with a contact bridge and a housing, each according to one of the embodiments described above, wherein the housing accommodates the contact bridge. The connector benefits from the functions and advantages of the contact bridge and the housing already described, making it suitable for connecting the busbars while simultaneously compensating for tolerances.

The invention is explained below by way of example with reference to the drawings. The embodiments shown represent only a subset of possible combinations of features. Individual features of an embodiment can be omitted in accordance with the above explanations if the technical effect associated with the respective feature is not relevant for a particular application. Conversely, a feature can be added to a described embodiment if the technical effect associated with this feature is relevant for a particular application of the embodiment.

### BRIEF DESCRIPTION OF THE DRAWINGS

In the drawings, the same reference numerals are used for features that correspond to each other in terms of function and/or structure.

FIG. 1 is a schematic perspective view of a contact bridge according to an exemplary embodiment;

FIG. 2 is a further schematic perspective view of the contact bridge from FIG. 1 and two busbars;

FIG. 3 is a further schematic perspective view of the contact bridge from FIG. 1;

FIG. 4 is a schematic perspective sectional view of the contact bridge along section plane IV-IV from FIG. 3 as a detailed view;

FIG. 5 is a schematic representation of the contact bridge according to another exemplary embodiment as a side view;

FIG. 6 is a schematic representation of a connector according to an exemplary embodiment as a side view;

FIG. 7 is a schematic perspective view of the contact bridge according to a further exemplary embodiment;

FIG. 8 is a schematic perspective sectional view of the connector according to a further exemplary embodiment;

FIG. 9 is a schematic perspective sectional view of the connector according to a further exemplary embodiment;

FIG. 10 is a schematic perspective view of the connector according to a further exemplary embodiment;

FIG. 11 is a schematic perspective view of the contact bridge according to a further exemplary embodiment;

FIG. 12 is a schematic perspective view of the contact bridge according to a further exemplary embodiment;

FIG. 13 is a schematic perspective view of the contact bridge according to a further exemplary embodiment;

FIG. 14 is a schematic perspective view of the contact bridge according to a further exemplary embodiment;

FIG. 15 is a schematic perspective view of the contact bridge according to a further exemplary embodiment; and

FIG. 16 is a schematic perspective view of the contact bridge according to a further exemplary embodiment.

### DETAILED DESCRIPTION OF THE INVENTION

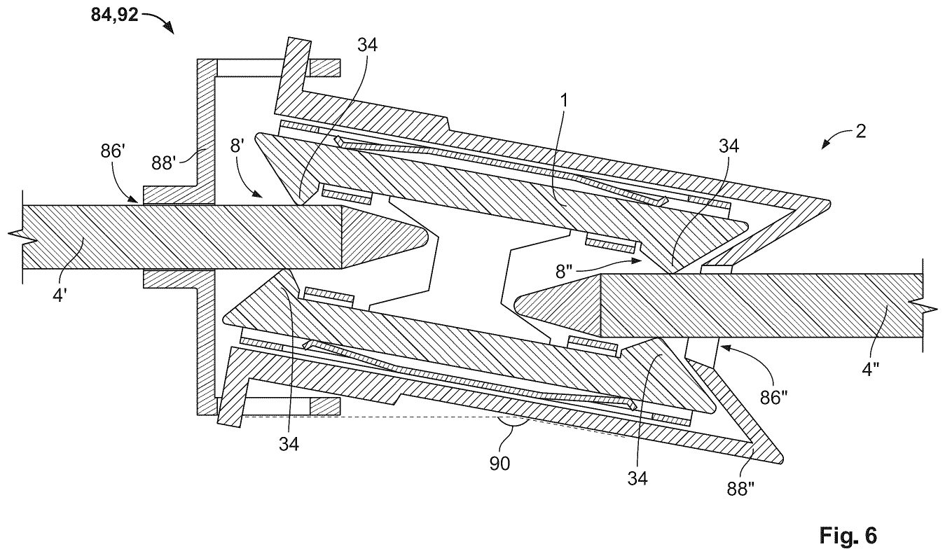

The structure and function of a contact bridge 1 is described below with reference to FIGS. 1 to 16. Furthermore, the structure and function of a connector 2 is explained with reference to FIGS. 6, 8, 9, and 10.

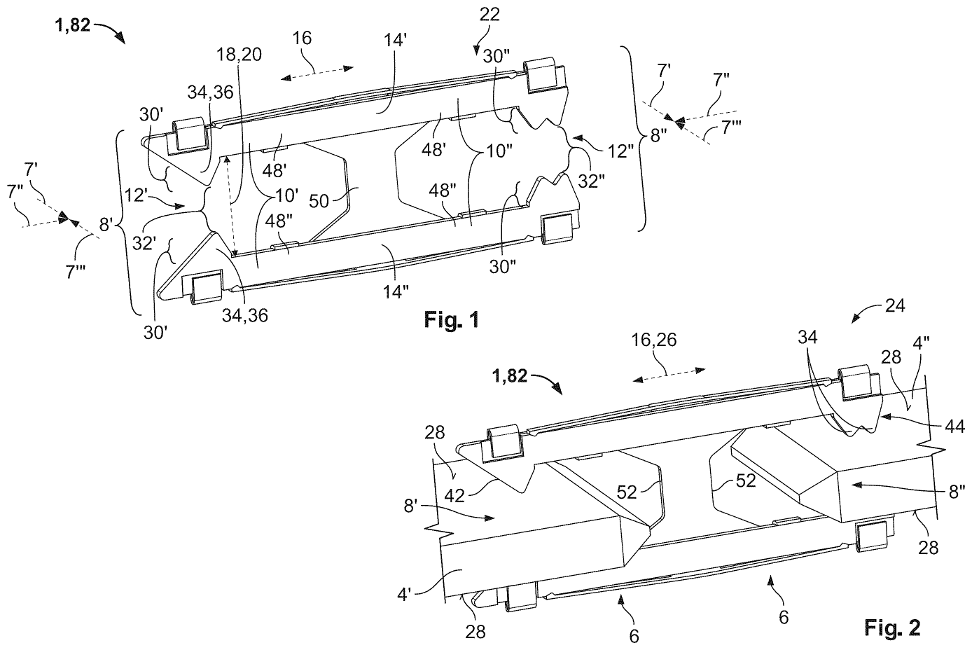

FIG. 1 shows a schematic perspective view of the contact bridge 1. As can be seen from FIG. 2, the contact bridge 1 serves to connect a first busbar 4′ to a second busbar 4″. The busbars 4′, 4″ belong, for example, to different electrical modules (not shown) which are to be connected or bridged with the contact bridge 1 for the transmission of electrical currents and/or signals. In particular, it may be the respective ends 6 of the busbars 4′, 4″ that are connected to each other.

For this purpose, the contact bridge 1 comprises a first clamp mouth 8′ for at least partially receiving the first busbar 4′, in particular its end 6. For example, the contact bridge 1 may comprise a first pair of clamping jaws 10′ that form the first clamp mouth 8′. The first pair of clamping jaws 10′ delimits a first clamping gap 12′, which is accessible to the first busbar 4′ from up to three mutually perpendicular directions 7′, 7″, 7′″. In other words, the end 6 of the first busbar 4′ can be inserted into the first clamping gap 12′ from one of the three directions 7′, 7″, 7′″ as required.

Furthermore, the contact bridge 1 comprises a second clamp mouth 8″ facing away from the first clamp mouth 8′ for at least partially receiving the second busbar 4″, in particular its end 6. Similarly, the contact bridge 1 may comprise a second pair of clamping jaws 10″ that form the second clamp mouth 8″. The second pair of clamping jaws 10″ thus defines a second clamping gap 12″ which is accessible to the second busbar 4″ from up to three mutually perpendicular directions 7′, 7″, 7′″. Here as well, the end 6 of the second busbar 4″ can be inserted into the second clamping gap 12″ from each of the three directions 7′, 7″, 7′″.

Preferably, the busbars 4′, 4″ are moved toward each other when inserted into the clamping gaps 12′, 12″, as shown in FIG. 2. However, if necessary, the busbars 4′, 4″ can also be inserted into the clamping gaps 12′, 12″ from the side. For example, the contact bridge 1 can be placed or pushed onto the ends 6 of the busbars 4′, 4″ laterally.

When the end 6 of the first busbar 4′ is inserted into the first clamp mouth 8′ and the end 6 of the second busbar 4″ is inserted into the second clamp mouth 8″, the electrical currents and/or signals are transmitted between the busbars 4′, 4″, since the first clamp mouth 8′ is electrically conductively connected to the second clamp mouth 8″.

For this purpose, the contact bridge 1 may comprise a first bracket element 14′ that extends from the first clamping gap 12′ to the second clamping gap 12″. In addition, the contact bridge 1 may comprise a second bracket element 14″ that also extends from the first clamping gap 12′ to the second clamping gap 12″. The bracket elements 14′, 14″ are preferably made of an electrically conductive material (e.g., aluminum, copper, or an alloy thereof) and are located opposite each other with respect to the first and second clamping gaps 12′, 12″.

The first bracket element 14′ may extend along a longitudinal direction 16. The second bracket element 14″ may be spaced transversely, in particular perpendicularly to the longitudinal direction 16, from the first bracket element 14′. A distance 18 between the first and second bracket elements 14′, 14″ measured perpendicular to the longitudinal direction 16 thus corresponds to a respective clear width 20 of the first and second clamp mouths 8′, 8″.

FIG. 1 shows a force-free state 22 of the contact bridge 1, in which the second bracket element 14″ extends parallel to the first bracket element 14′ in the longitudinal direction 16. In the installed state 24 (see FIG. 2) of the contact bridge 1, the longitudinal direction 16 may run along a connecting line between the first busbar 4′ and the second busbar 4″. The longitudinal direction 16 then corresponds to a busbar bridging direction 26. Optionally, the second bracket element 14″ may be configured identically to the first bracket element 14′ and arranged mirror-invertedly with respect to the clamping gaps 12′, 12″.

The first and second busbars 4′, 4″ may each comprise two flat sides 28 that are parallel to each other. Contact can be achieved on these flat sides 28 by means of the contact bridge 1. For this purpose, the first bracket element 14′ may comprise a first contact area 30′ that tapers the first clamp mouth 8′ and a second contact area 30″ that tapers the second clamp mouth 8″. Similarly, the second bracket element 14″ may comprise a first contact area 30′ that tapers the first clamp mouth 8″ and a second contact area 30″ that tapers the second clamp mouth 8″. The first contact areas 30′ are opposite each other with respect to the first clamping gap 12′, while the second contact areas 30″ are arranged opposite each other with respect to the second clamping gap 12″. This allows the contact areas to create constrictions 32′, 32″ in the respective clamp mouths 8′, 8″, which selectively generate increased contact force against the received busbars 4′, 4″. The first clamp mouth 8′ therefore comprises a first constriction 32′, and the second clamp mouth 8″ comprises a second constriction 32″.

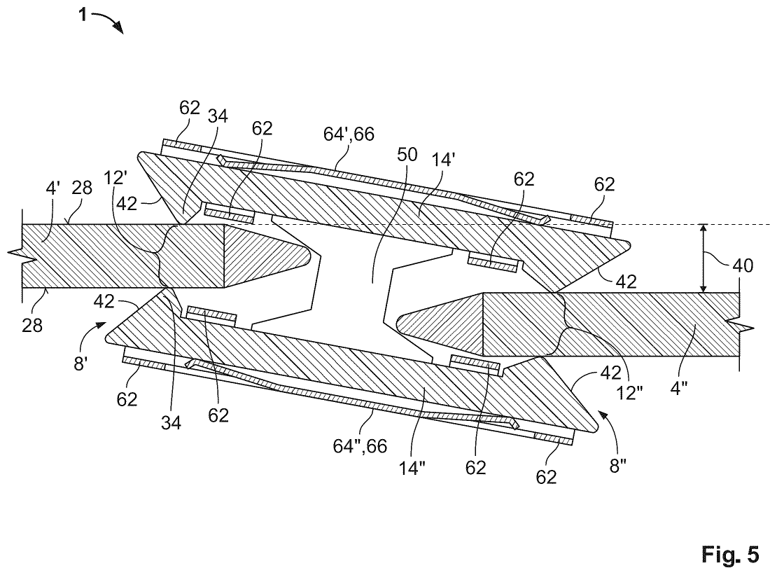

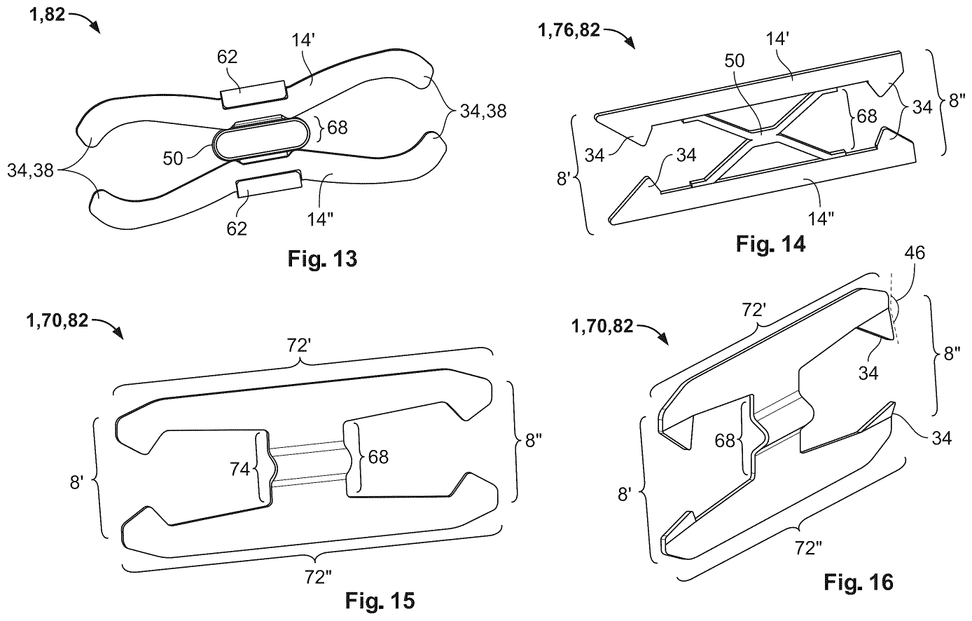

As shown in FIG. 1, the first contact area 30′ of the first bracket element 14′ and the first contact area 30′ of the second bracket element 14″ may each comprise a tip 34. The tip 34 may be formed by an angular prong 36 of the corresponding bracket element 14′, 14″ and protrude into the first clamp mouth 8′. Alternatively, rounded protrusions 38 of the bracket elements 14′, 14″ may also form the respective tip 34 (see FIG. 13). The contact bridge 1 can roll on the busbars 4′, 4″ with the respective tip. Consequently, the contact bridge 1 can connect the busbars 4′, 4″ even if there is a height offset 40 (see FIG. 5) or another type of position tolerance between the busbars 4′, 4″.

The tips 34 shown each comprise an insertion bevel 42 for the busbar to be received. From the perspective of the busbar being received, the first clamp mouth 8′ may widen behind the first constriction 32′ and the second clamp mouth 8″ may widen behind the second constriction 32″. These widenings give the respective busbar increased freedom of movement when the contact bridge 1 rolls on the busbars 4′, 4″ (see FIG. 5).

The second contact area 30″ of the first bracket element 14′ and the second contact area 30″ of the second bracket element 14″ may in turn each comprise a double tip 44. The double tip 44 may be two rounded or angular tips 34 that are aligned in the longitudinal direction 16. Perpendicular to the longitudinal direction 16, the two tips 34 are of equal length, so that the double tip 44 defines a central alignment when the contact bridge 1 is clamped to a busbar on one side.

In order to achieve additional flexibility in the contact areas, the respective tip 34 and/or the respective double tip 44 may be angled or bent relative to the rest of the contact bridge 1. This means that an angle 46 other than 180° is enclosed between the individual tips 34 and the rest of the contact bridge 1 (see FIG. 16).

As can be seen from FIG. 1, the first bracket element 14′ may form a first clamping jaw 48′ of the first pair of clamping jaws 10″ and a first clamping jaw 48′ of the second pair of clamping jaws 10″, while the second bracket element 14″ forms a second clamping jaw 48″ of the first pair of clamping jaws 10″ and a second clamping jaw 48″ of the second pair of clamping jaws 10″. The pairs clamping jaws 10′, 10″ are therefore coupled to each other in their movement via the bracket elements 14′, 14″, so that there is a motion-transmitting connection between them. In other words, a movement (e.g., opening or closing) of the first clamp mouth 8′ causes a movement (e.g., opening or closing) in the second clamp mouth 8″ and vice versa. This ensures that any compensatory movements necessary to overcome positional tolerances are distributed evenly between the first and second clamp mouths 8′, 8″.

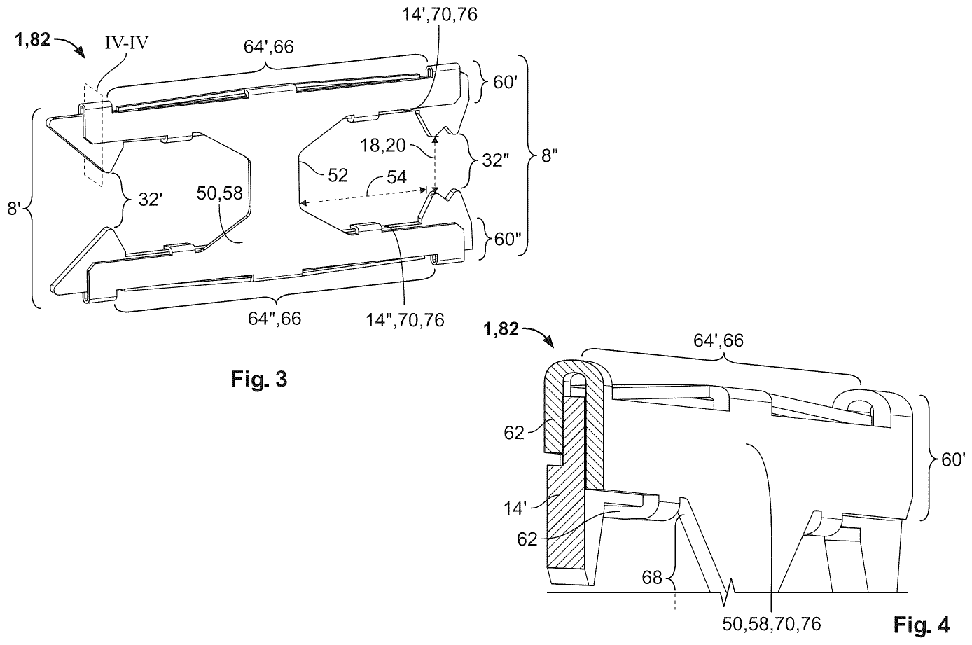

The contact bridge 1 is configured with its first and second clamp mouths 8′, 8″ as a spring-loaded double clamp or double-sided clamp. As can be seen in FIG. 3, the contact bridge 1 comprises a spring assembly 50 against which the first clamp mouth 8′ and the second clamp mouth 8″ are each configured to be openable. This means that an elastic restoring force of the spring assembly 50 must be overcome when opening or expanding the first and second clamp mouths 8′, 8″. This elastic restoring force of the spring assembly 50 enables the contact areas of the contact bridge 1 to apply the necessary contact force against the received busbars.

The clamping jaws 48′, 48″ of the pairs of clamping jaws 10′, 10″ may be held movable relative to each other under elastic deformation of the spring assembly 50. In particular, the spring assembly 50 may form a bearing point or pivot point for the first pair of clamping jaws 10′ and the second pair of clamping jaws 10″. In other words, the clamping jaws 48′, 48″ of the pairs of clamping jaws 10′, 10″ may be mounted in a rocking, tilting, or pivoting manner by the spring assembly 50. Here, the imaginary bearing point or pivot point may be located in the spring assembly 50 or outside the spring assembly 50.

The spring assembly 50 may extend at least partially between the first clamp mouth 8′ and the second clamp mouth 8″. In other words, the spring assembly 50 may separate the first clamp mouth 8′ from the second clamp mouth 8″. Optionally, the spring assembly 50 may form a stop 52 for each of the first and second busbars 4′, 4″. Optionally, in the first and second clamp mouths 8′, 8″, a distance 54 measured in the longitudinal direction 16 between the constriction 32 and the stop 52 may be smaller than the clear width 20 of the constriction 32. In other words, the first and second clamp mouths 8′, 8″ are then deeper than they are wide.

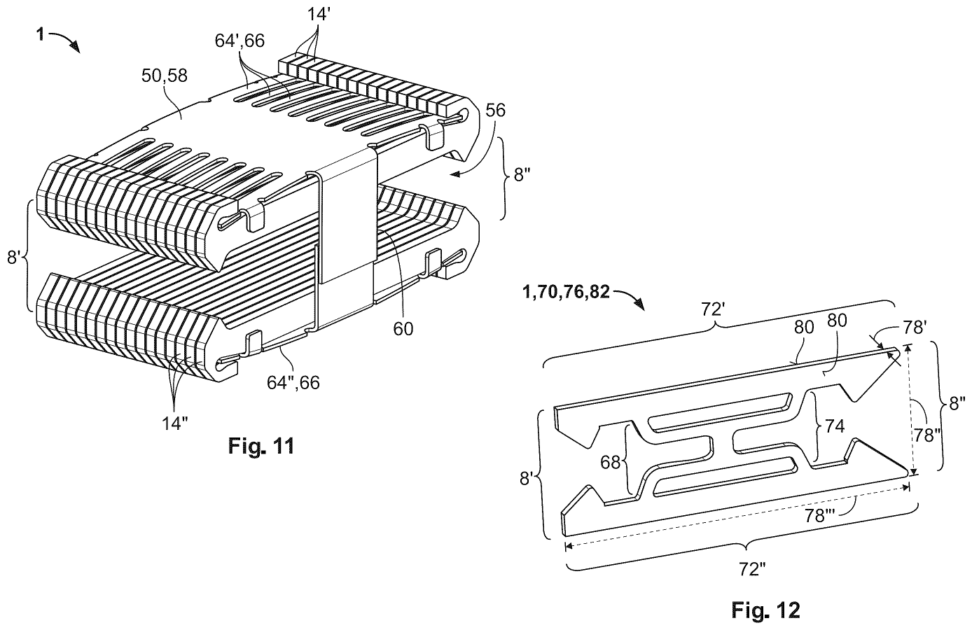

According to an alternative embodiment shown in FIG. 11, the first and second clamp mouths 8′, 8″ may form a continuous receiving channel 56 for the first and second busbars 4′, 4″. Here, the spring assembly 50 may surround the receiving channel 56.

The spring assembly 50 may be arranged centrally between the first clamp mouth 8′ and the second clamp mouth 8″. If the ends 6 of the first and second busbars 4′, 4″ have the same geometry, the first clamp mouth 8′ may be configured to be the same size as the second clamp mouth 8″. In particular, the first and second clamp mouths 8′, 8″ may be configured symmetrically with respect to the spring assembly 50 (see FIG. 15). If there are differences in the geometries of the busbar ends, this can be reflected in the size and shape of the clamp mouths.

As shown in FIG. 3, the spring assembly 50 may comprise a retaining spring 58 that connects the first bracket element 14′ to the second bracket element 14″ in a form-fitting manner. Thus, the first bracket element 14′, the second bracket element 14″, and the retaining spring 58 may each be separate components. In particular, the retaining spring 58 may be made of a different material with higher elasticity than the bracket elements 14′, 14″ (e.g., spring steel).

The retaining spring 58 may comprise a first connection area 60′ for form-fitting connection to the first bracket element 14′ and a second connection area 60″ for form-fitting connection to the second bracket element 14″. In particular, the connection areas 60′, 60″ may surround the respective bracket element 14′, 14″. For example, the connection areas 60′, 60″ may comprise form-fitting tabs 62 which surround the associated bracket element 14′, 14″ from at least two opposite sides and hold it in place captively (see FIG. 4).

Furthermore, the retaining spring 58 may comprise a first pressure area 64′ for preloading the first bracket element 14′ in the direction of the second bracket element 14″ and a second pressure area 64″ for preloading the second bracket element 14″ in the direction of the first bracket element 14′. The first pressure area 64′ is supported by the first connection area 60′, while the second pressure area 64″ is supported by the second connection area 60″. For example, the first and second pressure areas 64′, 64″ may each be configured as a leaf spring 66, which preloads the captive bracket element 14′, 14″.

The connection areas 60′, 60″ may be connected to each other by a middle section 68. It is this middle section 68 that forms the respective stop 52 for the first and second busbars 4′, 4″. As shown in FIG. 1, the bracket elements 14′, 14″ and the middle section 68 may each be located between the pressure areas 64′, 64″. The connection areas 60′, 60″ are located optionally between the middle section 68 and the associated pressure area 64′, 64″.

In FIG. 3, the middle section 68 is shown as straight and beam-shaped. Furthermore, the middle section 68 runs laterally offset from the bracket elements 14′, 14″ (see FIG. 1). However, the middle section 68 may also be ring-shaped (see FIG. 13), cross-shaped (see FIG. 14), and/or corrugated (see FIGS. 15 and 16). In addition, the middle section 68 may run exactly between the bracket elements 14′, 14″.

Alternatively or in addition to the form-fitting connection just described, there may be a material-joining connection between the retaining spring 58 and the first bracket element 14′, as well as between the retaining spring 58 and the second bracket element 14″. For example, the connection areas 60′, 60″ may be welded to the corresponding bracket element 14 (see FIG. 14).

According to a further alternative embodiment, the first clamp mouth 8′, the second clamp mouth 8′, and the spring assembly 50′ may be configured as a single piece, in particular as a monolithic piece. For example, the contact bridge 1 may be provided as a stamped and bent part 70. As such, the contact bridge 1 may comprise a first leg section 72′ and a second leg section 72″ for bridging the first and second busbars 4′, 4″ respectively. The first and second leg sections 72′, 72″ correspond in their function and position to the first and second bracket elements 14′, 14″. This means that the first and second leg sections 72′, 72″ each extend from the first clamping gap 12′ to the second clamping gap 12″. In addition, the first and second leg sections 72′, 72″ are opposite each other with respect to the first and second clamping gaps 12′, 12″.

Furthermore, the contact bridge 1 may then comprise a spring section 74 for clamping (i.e., pressing together or pulling together) the first and second leg sections 72′, 72″. Here, the spring section 74 extends from the first leg section 72′ to the second leg section 72″ and is functionally comparable to the retaining spring 58, in particular its middle section 68.

The stamped and bent part 70 from FIG. 12 is optionally configured as a flat body 76. It is therefore a flat, planar, plate-shaped or tab-shaped component with a spatial dimension 78′ that is many times smaller than its remaining dimensions 78″, 78′″. Furthermore, the stamped and bent part 70 comprises two flat sides 80 that point away from each other and whose distance corresponds to the smaller spatial dimension 78′ mentioned above. Similarly, the first bracket element 14′, the second bracket element 14″ and/or the retaining spring 58 may each be configured as flat bodies 76 with two flat sides 80.

In order to give the first bracket element 14′, the second bracket element 14″, the retaining spring 58 and/or the stamped-bent part 70 sufficient rigidity despite their design as flat bodies 76, it is advisable to align their flat sides 80 parallel to the above-mentioned clear width 20 of the first and second clamp mouths 8′. 8″. In other words, the first bracket element 14′, the second bracket element 14″, the retaining spring 58 and/or the stamped-bent part 70 may be arranged upright with respect to the busbars 4′, 4″. This increases the area moment of inertia of the respective flat body 76.

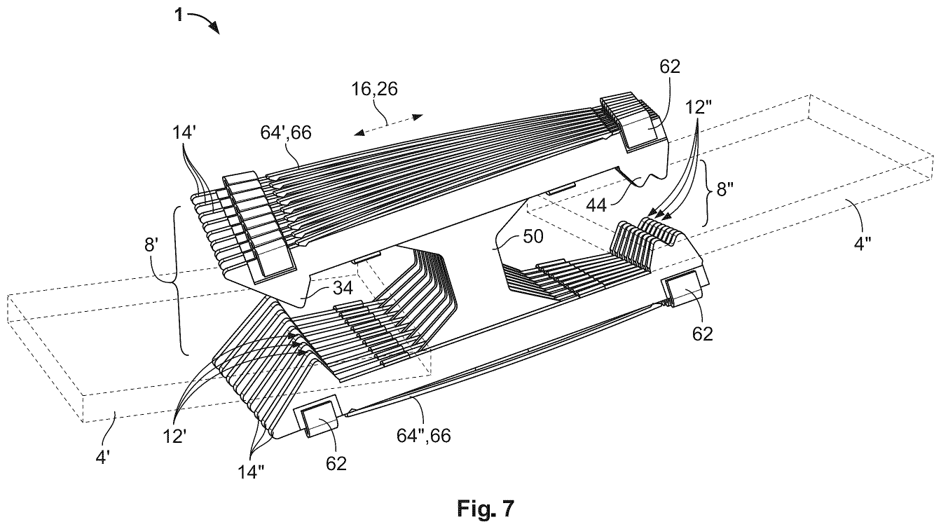

As shown in FIG. 7, the contact bridge 1 may comprise a plurality of first bracket elements 14′, which are arranged congruently or coincidently with respect to each other, and a plurality of second bracket elements 14″, which are arranged congruently or coincidently with respect to each other. The first bracket elements 14′ may be movable relative to each other, just as the second bracket elements 14″ may be movable relative to each other. In other words, in this embodiment, several first bracket elements 14′ and several second bracket elements 14″ are arranged or stacked next to each other, so that the contact bridge 1 has a larger overall conductor cross-sectional area.

Optionally, the contact bridge 1 may comprise an equal or symmetrical number of first and second bracket elements 14′, 14″. The spring assembly 50 may in turn comprise a corresponding number of retaining springs 58, which are arranged congruently to each other and can be displaced relative to each other, with each retaining spring 58 connecting a first bracket element 14′ to a second bracket element 14″ in pairs.

In other words, one first bracket element 14′, one second bracket element 14″ and one retaining spring 58 may together form a bridge unit 82, whereby the contact bridge 1 consists of a stack of such bridge units 82. Due to the congruent arrangement of the first bracket elements 14′, second bracket elements 14″ and retaining springs 58 with each other, the entirety of all first clamping gaps 12′ of the bridge units 82 results in the (common) first clamp mouth 8′ and the entirety of all second clamping gaps 12″ of the bridge units 82 results in the (common) second clamp mouth 8″.

Due to their movability, the bridge units 82 of the contact bridge 1 can be fanned out, as shown in FIG. 7. As long as a certain overlap between all adjacent clamping gaps 12′, 12″ remains, the individual clamping gaps 12′, 12″ can be displaced relative to each other by fanning out, so that a “distorted” overall gap results in the respective clamp mouth 8′, 8″. In total, the (common) first clamp mouth 8′ can thus be rotated relative to the (common) second clamp mouth 8″. Due to this design, tolerance compensation can also take place when the first and second busbars 4′, 4″ are rolled relative to each other due to tolerances (i.e., rotated around the busbar bridging direction 26).

As can be seen from FIG. 7, each bridge unit 82 comprises its own retaining spring 58, which is mechanically independent of the other retaining springs 58 of the other bridge units 82. Thus, even after a strong tolerance compensation, the contact forces within each bridge unit 82 are reliably exerted by its own retaining spring 58. According to the alternative embodiment shown in FIG. 11, the spring assembly 50 may also comprise only one retaining spring 58, which bundles and collectively connects all first and second bracket elements 14′, 14″. In this case, the spring assembly 50 may comprise several first pressure areas 64′ for preloading the first bracket elements 14′ in the direction of the second bracket elements 14″ and several second pressure areas 64″ for preloading the second bracket elements 14″ in the direction of the first bracket elements 14′.

FIG. 6 shows the connector 2 with a housing 84 for the contact bridge 1. The housing 84 is made of an electrically insulating material and is configured to accommodate the contact bridge 1. Furthermore, the housing 84 may comprise a first access opening 86′ for inserting the first busbars 4″ and a second access opening 86″ for inserting the second busbars 4″. When the contact bridge 1 is accommodated in the housing 84, the first access opening 86′ may open into the first clamp mouth 8′, and the second access opening 86″ may open into the second clamp mouth 8″.

Optionally, the housing 84 may comprise a first housing part 88′ forming the first access opening 86′ and a second housing part 88″ forming the second access opening 86″, wherein the first and second housing parts 88′, 88″ are held together in an angularly movable manner. The angular mobility describes the fact that an angle 90 between the housing parts 88′, 88″ is variable. For example, the housing parts 88′, 88″ may form a joint 92, inside which the contact bridge 1 is located. Alternatively, the housing parts 88′, 88″ may be connected by a film hinge or an elastic hose segment.

The angular mobility or flexibility allows the housing parts 88′, 88″ to be aligned to match the orientations and heights of the busbars 4′, 4″ to be received. For example, the same height offset can be set between the access openings 86′, 86″ as it exists between the busbars 4′, 4″. Similarly, the same angle can be set between the housing parts 88′, 88″ as it exists between the busbars 4′, 4″.

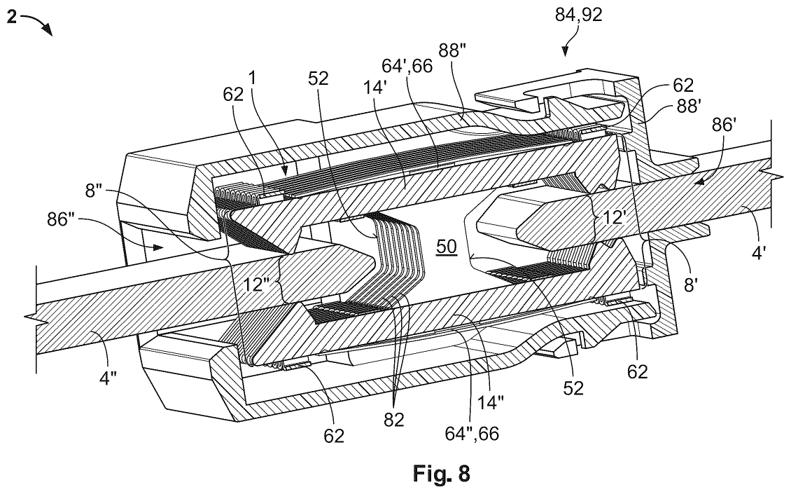

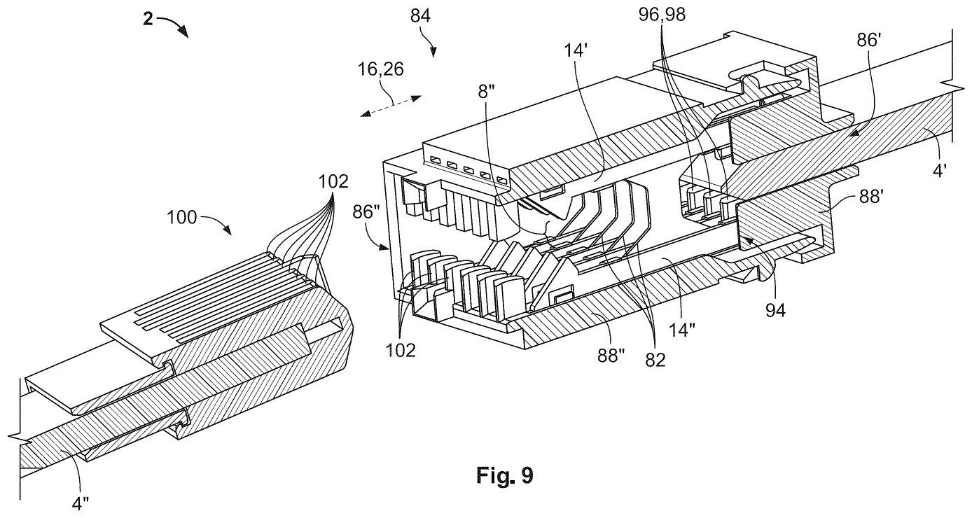

As shown in FIG. 8, the housing 84 may bundle the stack of several bridge units 82. Optionally, the housing 84 may comprise at least one spacer grid 94 with a plurality of parallel spacer ribs 96. The spacer ribs 96 may be configured as inner ribs 98 which protrude into the interior of the housing 84 and between the individual bridge units 82 (see FIG. 9). This allows the spacer grid 94 to serve to position the individual bridge units 82, in particular the plurality of first and second bracket elements 14′, 14″, at predefined intervals, for example at regular intervals. In addition, the spacer grid 94 may be configured to align the bridge units 82 within the housing 84 in the busbar bridging direction 26.

Alternatively, the contact bridge 1 may be provided as a stack of several stamped and bent parts 70 with the leg sections 72′, 72″ and the spring section 74 already described above. In this case, too, the housing 84 may be used to bundle, align, and grid this stack.

FIG. 9 shows that the housing 84 may comprise at least one finger protection grid 100 for placing on the first and/or second busbar 4′, 4″. The finger protection grid 100 may be provided in addition to the first and second housing parts 88′, 88″. Furthermore, the finger protection grid 100 may be configured as a comb, grid, grate, grill, or gate-shaped structure which may be placed on the end 6 of the first or second busbar 4′, 4″. In particular, the finger protection grid 100 may comprise a plurality of parallel finger protection ribs 102 which, when fitted, enclose the end 6 of the first or second busbar 4′, 4″.

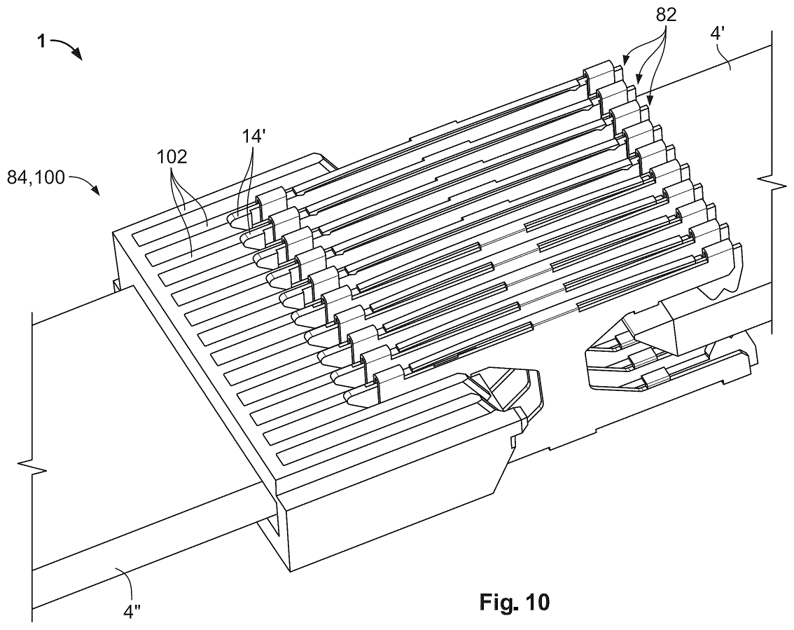

The finger protection ribs 102 are dimensioned such that contact between the enclosed busbar and the contact bridge 1 is possible without obstruction, while a VDE test finger (not shown) cannot touch the enclosed busbar. To achieve this, it must be ensured that the bridge units 82 of the contact bridge 1, positioned by the spacer grid 94, engage individually between the finger protection ribs 102 of the finger protection grid 100 and thus reach the busbar (see FIG. 10). For this purpose, it is advantageous for the pitch of the finger protection ribs 102 to correspond to the pitch of the spacer ribs 96. Furthermore, the finger protection ribs 102 and spacer ribs 96 may have the same width or material thickness. At the same time, the pitch of the finger protection ribs 102 should be smaller than the tip of the VDE test finger, wherein the pitch describes the respective distance between adjacent ribs.

The first and/or second access opening 86′, 86″ of the housing may in turn be dimensioned such that the VDE test finger cannot be inserted as far as the first or second clamp mouth 8′, 8″, while a busbar with the finger protection grid 100 can fit in unhindered. For this purpose, further finger protection ribs 102 may be provided in the first and/or second access opening 86′, 86″ which cover the first or second clamp mouth 8′, 8″ in the busbar bridging direction 26. These additional finger protection ribs 102 are complementary in number, shape, and position to the finger protection ribs 102 of the finger protection grid 100.

In order to compensate for any positional tolerances of the finger protection grid 100, it is advisable to mount the finger protection grid so that it can be moved on the first or second busbar 4′, 4″.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Contact bridge for connecting a first busbar to a second busbar, wherein the contact bridge comprises:
a first clamp mouth for at least partially receiving the first busbar,
a second clamp mouth facing away from the first clamp mouth for at least partially receiving the second busbar, and
a spring assembly against which the first clamp mouth and the second clamp mouth are each configured to be openable,
wherein the first clamp mouth is connected to the second clamp mouth in an electrically conductive and motion-transmitting manner.

2. Contact bridge according to claim 1, wherein the spring assembly extends at least partially between the first clamp mouth and the second clamp mouth and forms a stop for the first and second busbars, respectively.

3. Contact bridge according to claim 1, wherein the contact bridge comprises
a first pair of clamping jaws forming the first clamp mouth and
a second pair of clamping jaws forming the second clamp mouth
wherein the spring assembly forms a bearing point for the first pair of clamping jaws and the second pair of clamping jaws, respectively.

4. Contact bridge according to claim 3, further comprising
a first bracket element extending along a longitudinal direction, and
a second bracket element spaced transversely to the longitudinal direction from the first bracket element,
wherein the first bracket element forms a first clamping jaw of the first pair of clamping jaws and a first clamping jaw of the second pair of clamping jaws, wherein the second bracket element forms a second clamping jaw of the first pair of clamping jaws and a second clamping jaw of the second pair of clamping jaws, wherein the spring assembly comprises a retaining spring which connects the first bracket element to the second bracket element in a form-fitting and/or material-joining manner.

5. Contact bridge according to claim 4, wherein the first bracket element, the second bracket element and/or the retaining spring are configured as flat bodies.

6. Contact bridge according to claim 4, wherein the first bracket element comprises a first contact area that tapers the first clamp mouth and a second contact area that tapers the second clamp mouth, and wherein the second bracket element comprises a first contact area that tapers the first clamp mouth and a second contact area that tapers the second clamp mouth.

7. Contact bridge according to claim 6, wherein the first and/or second contact area of the first bracket element and/or the first and/or second contact area of the second bracket element each comprises a tip or a double tip.

8. Contact bridge according to claim 7, wherein the respective tip and/or the respective double tip is angled relative to the rest of the contact bridge.

9. Contact bridge according to any one of claim 4, wherein the contact bridge comprises
a plurality of first bracket elements arranged congruently to one another, and
a plurality of second bracket elements arranged congruently to one another,
wherein the spring assembly comprises a plurality of retaining springs arranged congruently to one another, and wherein each retaining spring connects one first bracket element to one second bracket element in pairs.

10. Contact bridge according to claim 1, wherein the first clamp mouth, the second clamp mouth and the spring assembly are configured as a single piece.

11. Housing for a contact bridge according to claim 1, wherein the housing comprises a first access opening for inserting the first busbar and a second access opening for inserting the second busbar.

12. Housing according to claim 11, wherein the housing comprises a first housing part and a second housing part, wherein the first and second housing parts are held together in an angularly movable manner.

13. Housing according to claim 11, wherein the housing comprises at least one spacer grid with a plurality of spacer ribs, wherein the spacer grid is configured to position the plurality of first and second bracket elements at predefined intervals.

14. Housing according to claim 13, wherein
the contact bridge further comprises a plurality of first bracket elements each extending along a longitudinal direction and arranged congruently to one another, and a plurality of second bracket element arranged congruently to one another and spaced transversely to the longitudinal direction from the first bracket element, wherein the first bracket element forms a first clamping jaw of the first pair of clamping jaws and a first clamping jaw of the second pair of clamping jaws, wherein the second bracket element forms a second clamping jaw of the first pair of clamping jaws and a second clamping jaw of the second pair of clamping jaws, wherein the spring assembly comprises a plurality of retaining springs, wherein each retaining spring connects one first bracket element to one second bracket element in pairs in a form-fitting and/or material-joining manner arranged congruently to one another, and
the housing comprises at least one finger protection grid for placing on the first and/or second busbar, wherein the at least one finger protection grid comprises a plurality of finger protection ribs whose pitch corresponds to a pitch of the spacer ribs.

15. Connector comprising:
a contact bridge for connecting a first busbar to a second busbar, wherein the contact bridge includes a first clamp mouth for at least partially receiving the first busbar, a second clamp mouth facing away from the first clamp mouth for at least partially receiving the second busbar, and a spring assembly against which the first clamp mouth and the second clamp mouth are each configured to be openable, wherein the first clamp mouth is connected to the second clamp mouth in an electrically conductive and motion-transmitting manner; and
a housing accommodating the contact bridge, the housing including a first access opening for inserting the first busbar and a second access opening for inserting the second busbar.

16. Connector according to claim 15, wherein the spring assembly extends at least partially between the first clamp mouth and the second clamp mouth and forms a stop for the first and second busbars, respectively.

17. Connector according to claim 15, wherein the contact bridge comprises
a first pair of clamping jaws forming the first clamp mouth and
a second pair of clamping jaws forming the second clamp mouth
wherein the spring assembly forms a bearing point for the first pair of clamping jaws and the second pair of clamping jaws, respectively.

18. Connector according to claim 17, further comprising
a first bracket element extending along a longitudinal direction, and
a second bracket element spaced transversely to the longitudinal direction from the first bracket element,
wherein the first bracket element forms a first clamping jaw of the first pair of clamping jaws and a first clamping jaw of the second pair of clamping jaws, wherein the second bracket element forms a second clamping jaw of the first pair of clamping jaws and a second clamping jaw of the second pair of clamping jaws, wherein the spring assembly comprises a retaining spring which connects the first bracket element to the second bracket element in a form-fitting and/or material-joining manner.

19. Connector according to claim 18, wherein the first bracket element comprises a first contact area that tapers the first clamp mouth and a second contact area that tapers the second clamp mouth, and wherein the second bracket element comprises a first contact area that tapers the first clamp mouth and a second contact area that tapers the second clamp mouth.

20. Connector according to claim 18, wherein the contact bridge comprises
a plurality of first bracket elements arranged congruently to one another, and
a plurality of second bracket elements arranged congruently to one another,
wherein the spring assembly comprises a plurality of retaining springs arranged congruently to one another, and wherein each retaining spring connects one first bracket element to one second bracket element in pairs.
